(19) United States
(12) Patent Application Publication
(10) Pub. No.: US 2003/0005641 A1
(43) Pub. Date: Jan. 9, 2003

(54) Door support system and method

(76) Inventors: Marshall S. Eakes, Greensboro, NC (US); Joseph Mark Downey, Jamestown, NC (US); Michael S. Rook SR., Greensboro, NC (US)

Correspondence Address: Walter L. Beavers, 326 South Eugene Street, Greensboro, NC, 27401, US

(21) Appl. No.: 09/900,606

(22) Filed: Jul. 9, 2001

(51) Int. Cl. E06B 1/00

(52) U.S. Cl. 49/380

(57) ABSTRACT

A door support system and method are provided for manufacturers and distributors of pre-hung door assemblies as used in homes and other buildings. The door support system includes a molded, polymeric corner member, retainer which fits within the latch throat of the door and a door rest which is positioned on the edge of the door, between the threshold and the door bottom. With the door support system installed, the pre-hung door assembly can easily be transported and installed without damage or injury, even with rough handling.

### FIELD OF THE INVENTION

The invention herein pertains to pre-hung door assemblies and particularly pertains to means to support the door within the frame to prevent injury and damage prior to and during installation.

### DESCRIPTION OF THE PRIOR ART AND OBJECTIVES OF THE INVENTION

Pre-hung doors assemblies have become an increasingly popular way to save labor and material costs for companies and builders. Such pre-hung door assemblies generally include an outer frame and door hingedly affixed thereto. Knobs, latch assemblies and the like are not usually installed on pre-hung doors. Pre-hung exterior doors do include a threshold, conventionally with a vinyl seal or other weather stripping. While pre-hung doors include a pre-drilled latch throat and communicating channels for the hardware such is not installed. As the doors are hingedly joined to the frame, they can therefore inadvertently swing open during handling if not maintained in place. To remedy this problem various types of tapes, fasteners and connectors have been used in the past to maintain the door securely within the frame during shipment and installation. However, some of the measures taken to temporarily secure the door within the frame have caused problems in that certain of the temporary door restraint devices are difficult to employ and may malfunction. Others, once installed are difficult and time consuming to remove. Also, even if installed and used properly, certain of the prior restraint devices, during prolonged periods of storage do not prevent pre-hung doors from sagging and distorting vinyl weather stripping on the accompanying thresholds.

Thus, with the problems and disadvantages of pre-hung doors and conventional means of retaining them during shipment and installation, the present invention was conceived and one of its objectives is to provide a support system and method to securely maintain a pre-hung door within its frame while setting the proper gap between the door and the frame.

It is another objective of the present invention to provide a door support system for pre-hung doors which includes three separate components which work in concert to properly retain the pre-hung door within the frame as needed.

It is yet another objective of the present invention to provide a pre-hung door support system and method which is both easy to install and easy to remove after door installation.

It is a further objective of the present invention to provide a pre-hung door support system which includes an upper corner member, a retainer at the latch plate area and a door rest at the bottom corner of the door on the edge opposite the hinges for spacing the door from the threshold.

Various other objectives and advantages of the present invention will become apparent to those skilled in the art as a more detailed description is set forth below.

### SUMMARY OF THE INVENTION

The aforesaid and other objectives are realized by providing a door support system and method for pre-hung door assemblies which includes three separate components molded of suitable plastics. The components are affixed along the door edge, opposite the hinges which swingably join the door to the frame in a typical pre-hung configuration. At the upper edge of the door a corner member is affixed which can be stapled or otherwise temporarily joined to the top and front edge of the door. The corner member includes an L-shaped edge section which is integrally formed with a frame plate. When the door is closed within the frame the frame plate is then stapled to the door frame to prevent normal hinged movement of the door. Proximate the door knob and latch area along the front edge, a molded retainer is positioned into the latch plate indentation while the extension of the retainer is inserted into the latch throat of the door. The extension has an arcuate tip which grasps the inner periphery of the knob hardware channel and holds the retainer in place. A flange, also integrally molded as part of the retainer, is then stapled to the door frame along the bottom front edge of the door. A door rest is affixed to the bottom front edge of the door such as by standard staples. The door rest includes a cylindrically shaped foot which extends beneath the door. Thus, when the pre-hung door is shipped from the manufacturer and stored, the foot spaces the bottom of the door from the vinyl seal or weather stripping of the threshold, thus preventing the threshold from becoming distorted and rendered ineffective once the door assembly is installed in a house or other building. Also, the door retainer and corner member provide the proper gap between the door and the frame.

The method of using the door support system also includes removal of the corner member, retainer and door rest by removing the staples or other temporary fasteners to allow the door to operate in a normal fashion after installation is complete.

### BRIEF DESCRIPTION OF THE DRAWINGS

FIG. 1 illustrates the front of a typical pre-hung exterior door assembly with the door support system components of the present invention positioned thereon;

FIG. 1A shows an enlarged partial rear view of a portion of the door as seen in FIG. 1;

FIG. 2 demonstrates the door as seen in FIG. 1 as removed from the frame and threshold;

FIG. 3 pictures a front view of the door corner member of the door support system apart from the door;

FIG. 4 shows a rear view of the corner member as seen in FIG. 3;

FIG. 5 illustrates a perspective view of the corner member as shown in FIG. 3;

FIG. 6 depicts a top view of the corner member as shown in FIG. 3;

FIG. 7 pictures a side view of the corner member as shown in FIG. 5 along lines 7-7;

FIG. 8 presents another view of the corner member as shown in FIG. 5 along lines 8-8;

FIG. 9 demonstrates a front right side perspective view of the retainer as shown in FIG. 1 removed from the door;

FIG. 10 illustrates an end view of the corner member as shown in FIG. 9;

FIG. 11 depicts a front view of the retainer as seen in FIG. 10;

FIG. 12 pictures a view of the retainer along lines 12-12 as seen in FIG. 11;

FIG. 13 features a rear view of the retainer as shown in FIG. 11 along lines 13-13;

FIG. 14 demonstrates a front perspective of the door rest as shown in FIG. 1 as removed from the door;

FIG. 15 illustrates a bottom view of the door rest as shown in FIG. 14 along lines 15-15;

FIG. 16 shows a top view of the door rest as seen in FIG. 14 along lines 16-16;

FIG. 17 pictures a front view of the door rest as seen in FIG. 14;

FIG. 18 features a rear view of the door rest as seen in FIG. 14; and

FIG. 19 presents a side elevational view of the door rest as seen in FIG. 17 along lines 19-19.

### DETAILED DESCRIPTION OF THE PREFERRED EMBODIMENT AND OPERATION OF THE INVENTION

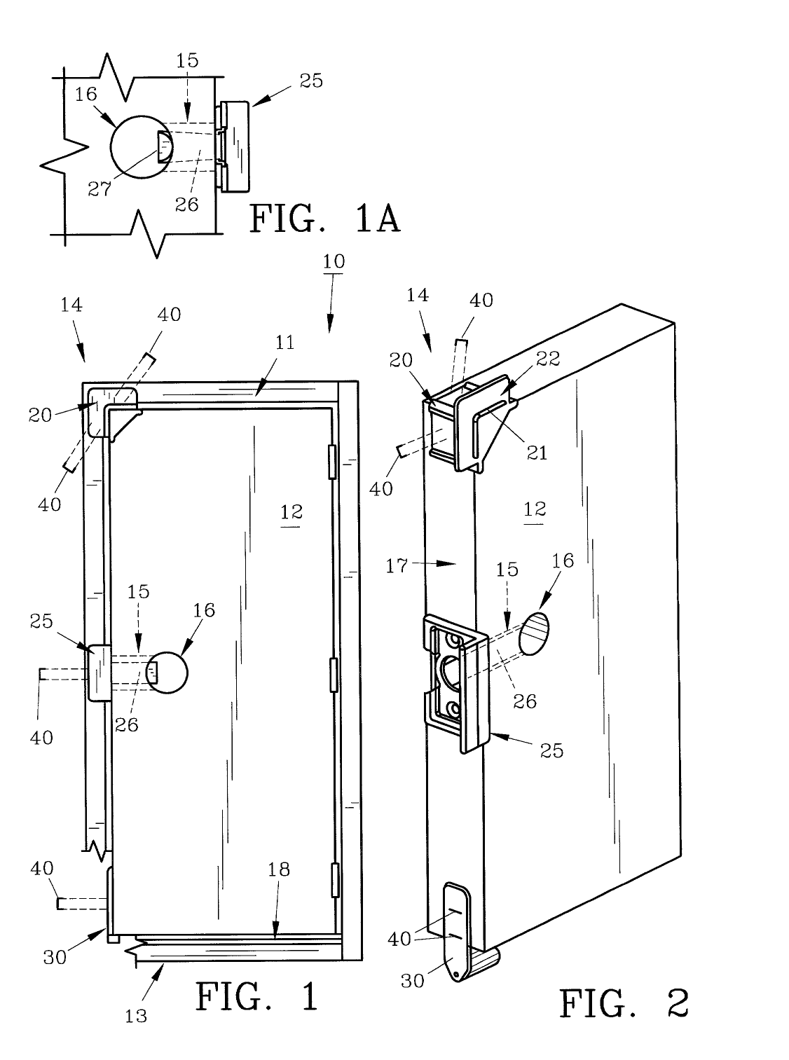

For a better understanding of the invention and its method operation, turning now to the drawings, FIG. 1 illustrates a typical pre-hung door assembly 10 including a frame 11 which is hingedly joined to door 12 with threshold 13 attached to frame 11. Frame 11 has been cut-away at the left, bottom corner for demonstrative purposes.

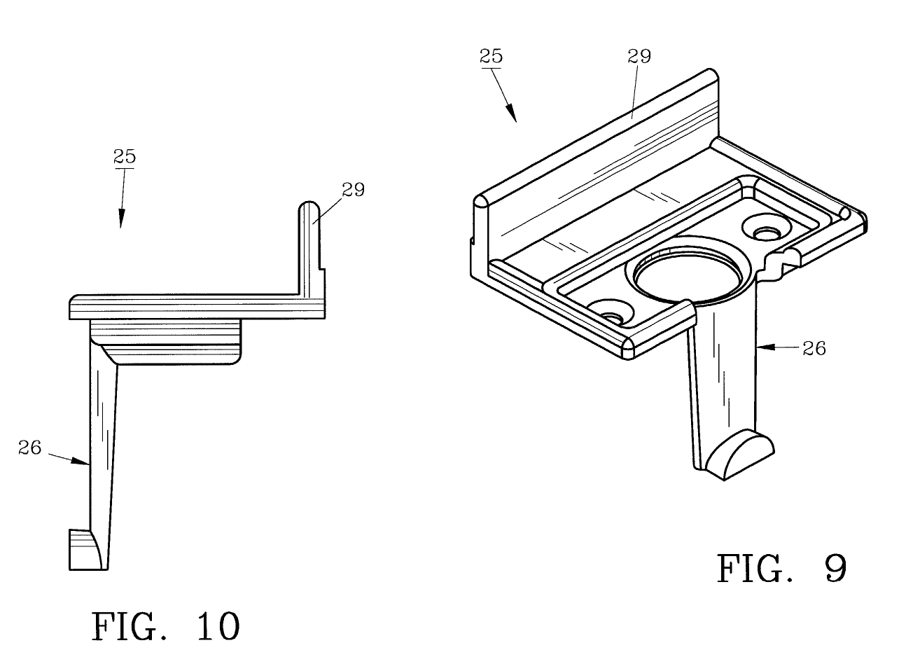

As would be understood, various types of pre-hung door assemblies are available in hardware stores, home improvement centers and the like without door hardware. Door 12 as shown is generally the exterior type and threshold 13 seen therewith. In order to safely, quickly and conveniently transport, handle and install pre-hung door assembly 10 preferred door support system 14 has been devised which includes preferred molded corner member 20, preferred retainer 25 and preferred door rest 30. Preferred door support system 14 is shown on door 12 removed from frame 11 and threshold 13 in FIG. 2. Preferred corner member 20 is positioned opposite the hinge side on the left upper corner of door 12, preferred door retainer 25 is positioned along the edge of the door where the latch plate would normally be affixed and includes extension 26 as seen in FIGS. 9 and 10 which is inserted through latch throat 15 of door 12 as shown in FIGS. 1A and 2. Extension 26 is shown in FIG. 1A with arcuate tip 27 of extension 26 engaging the inner perimeter of door hardware channel 16.

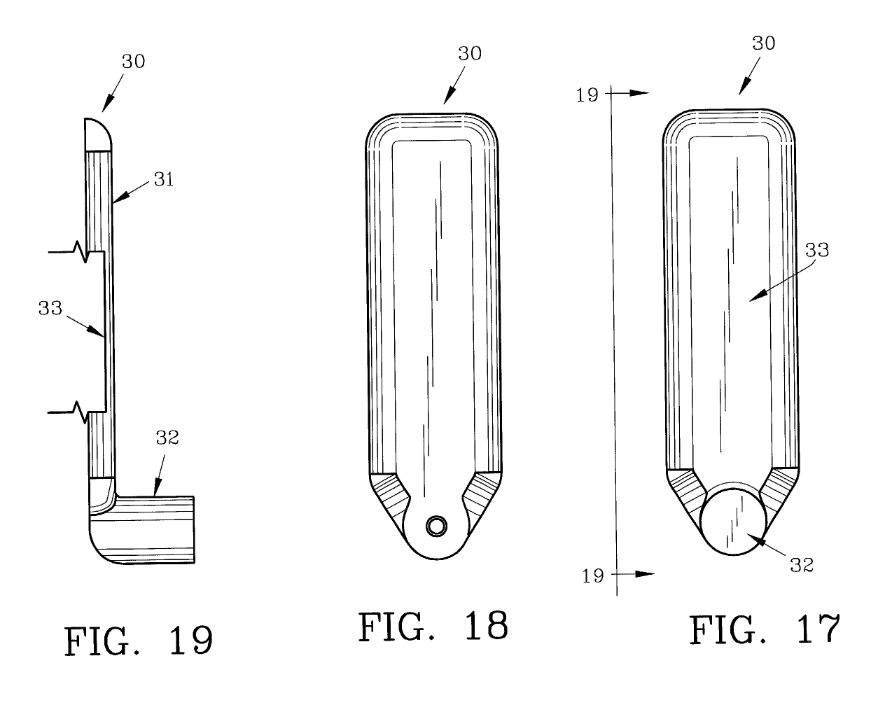

Also mounted on front edge 17 of door 12 at the bottom left corner as shown in FIGS. 1 and 2 is preferred door rest 30, seen in more detail in FIGS. 15-19. Door rest 30 includes a base 31 and cylindrically shaped foot 32. As shown in cut-away fashion in FIG. 19, base 31 has a thin front wall 33 which provides a large, thin section for driving, preferably a staple therethrough into door edge 17 (FIG. 2), although other temporary fasteners such as screws, tacks or the like may also be used. Foot 32 and base 31 of rest 30 are integrally molded of a suitable polymeric material, preferably polystyrene as is corner member 20 and retainer 25. Other polymeric materials such as polyethylene could be used but are not preferred. Foot 32 holds or spaces door 12 from threshold 13, thus preventing crushing and distorting of vinyl or other weather stripping materials affixed to threshold 13, during shipping and storage, before installation. Staples 40 are shown in FIGS. 1 and 2 which are the preferred fastener for holding corner member 20 and door support 30 in place on door 12 and frame 11, although other types of fasteners such as screws, tacks, rivets or the like may be used.

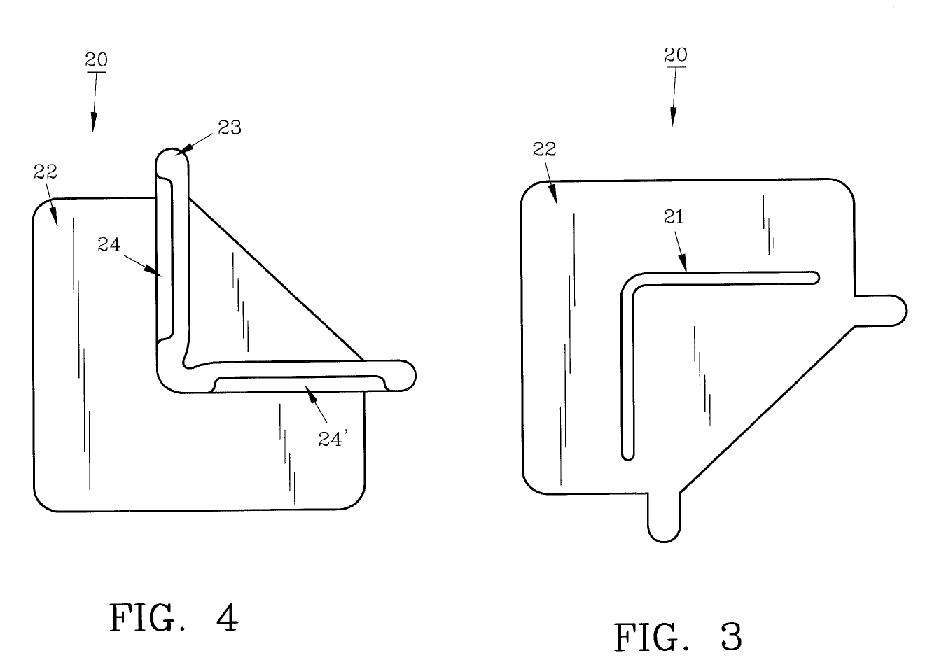

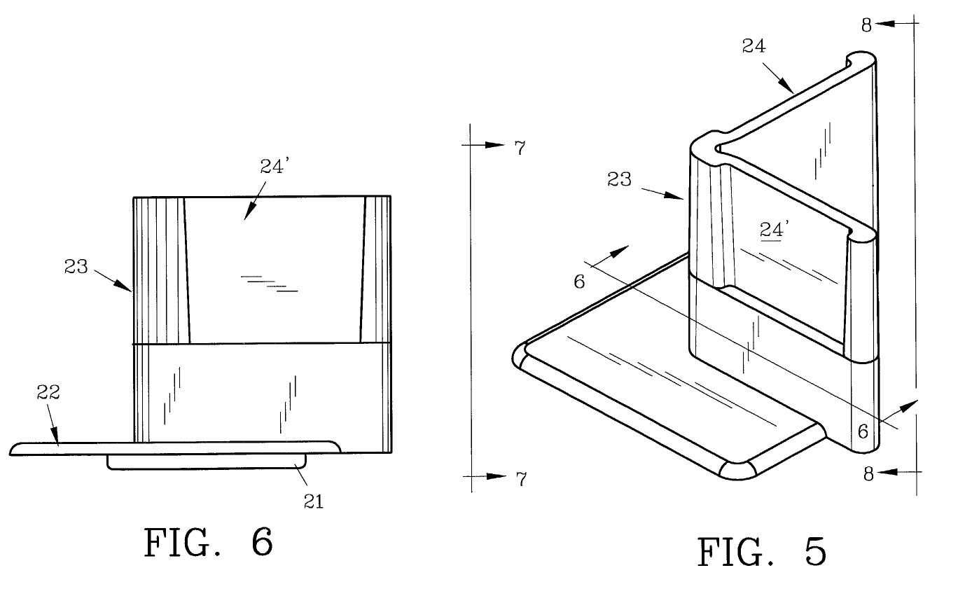

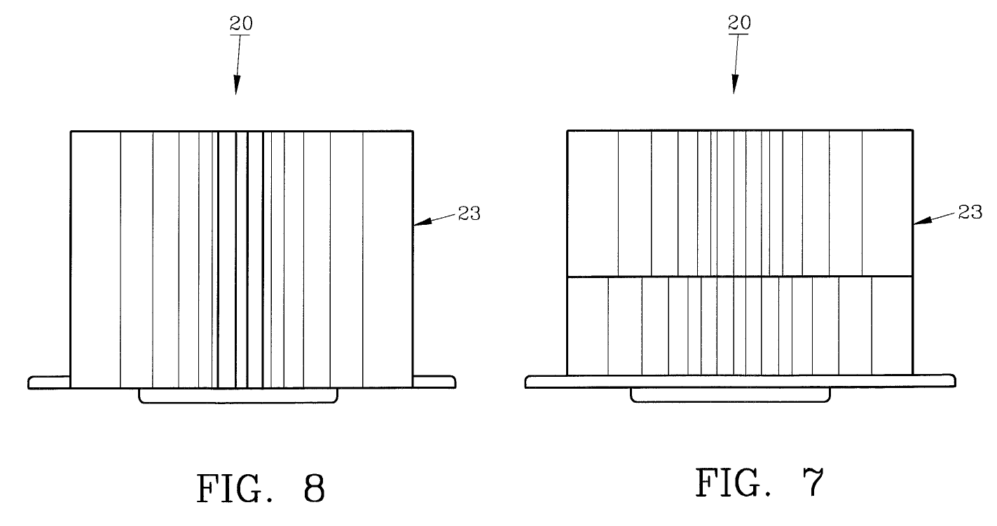

Preferred corner member 20 is shown enlarged and in various views in greater detail in FIGS. 3-8. In FIG. 3, corner member 20, also formed from a suitable molded polymeric material, is seen with raised staple guide 21 as formed on frame plate 22. L-shaped edge section 23 is depicted in FIGS. 4-8 having depressed areas 24, 24′ to allow staples or other fasteners to easily pass therethrough during attachment.

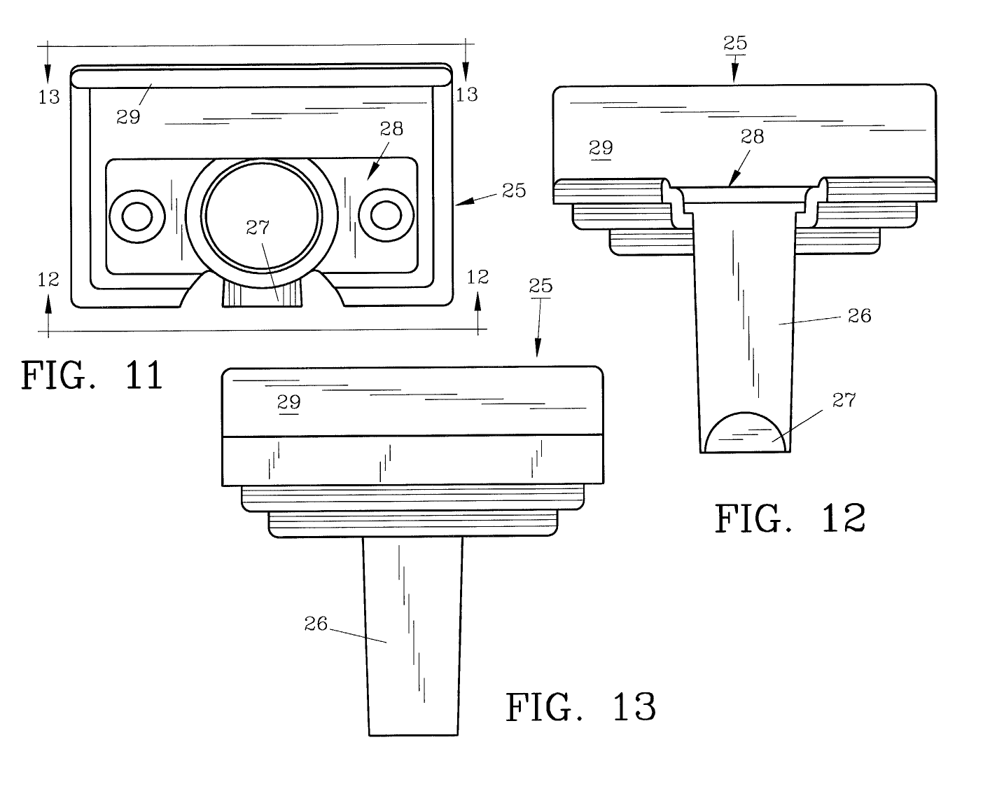

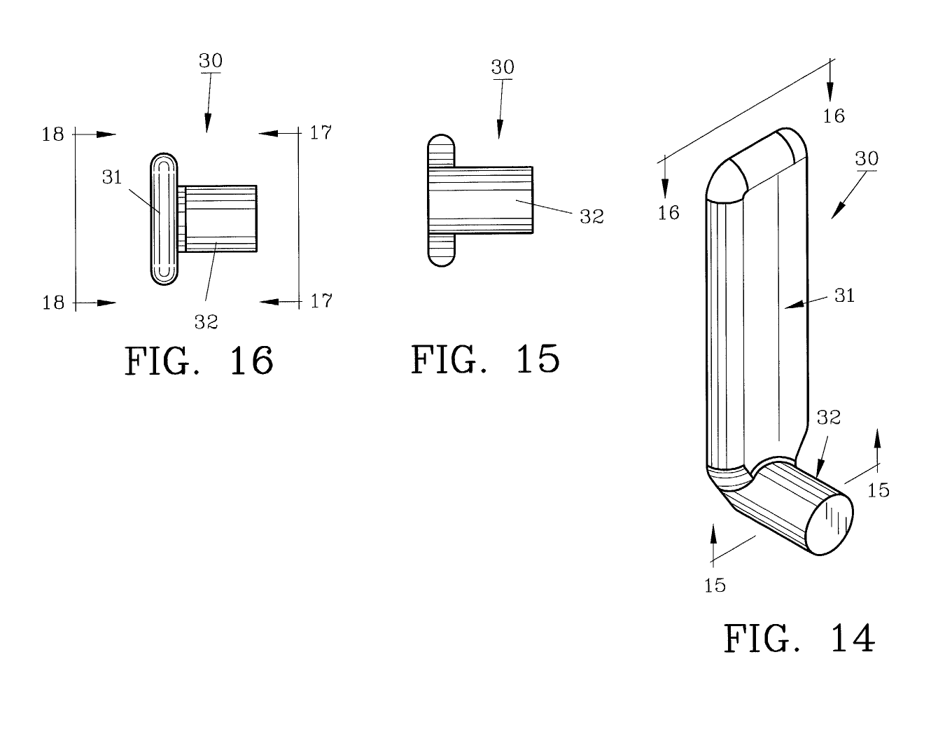

In FIGS. 9-13, various views of retainer 25 are seen including a perspective view in FIG. 9. Retainer 25 includes indented portion 28 which fits into the preformed latch plate indentation on front edge 17 of door 12 as seen in FIG. 2, and is held in place by extension 26 which passes through latch throat 15 as earlier described. Also, retainer 25 includes flange 29 which is stapled or otherwise affixed to door frame 11 to hold the same. Thus by affixing door 12 by the use of corner member 20, retainer 25 and door rest 30, pre-hung door 12 can be easily, safely and conveniently handled, shipped and installed. Pre-hung door assembly 10 is often pulled by various of its parts of the frame by potential purchasers while on display in stores and if not securely, releasably attached, door 12 can inadvertently swing open and be damaged or cause potential injury. Corner member 20 thus helps in preventing door 12 from swinging out of frame 11 while retainer 25 assists in holding door 12 within frame 11 when it is pulled away from door 12, such as during loading, unloading and inspection by consumers. Door rest 30 prevents door 12 from sagging within frame 11 and distorting and deforming vinyl weather stripping 18, seen on threshold 13 in FIG. 1. Foot 32 as seen in FIGS. 14, 17 and 19 stops the downward movement of front edge 17 of door 12, which may occur during handling and installation.

The preferred method of temporarily supporting pre-hung door 12 having latch throat 15 includes the steps of first attaching corner member 20 having staple guide 21 positioned on frame plate 22 with L-shaped edge section 23 having depressed areas 24, 24′ to the top of door 12, between door 12 and frame 11. Next, door retainer 25 having extension 26 with arcuate tip 27 positioned through latch throat 15 of door 12 whereby arcuate tip 27 engages the inner periphery of the door hardware channel 16. Next, door rest 30 having base 31 and cylindrical foot 32 is affixed by stapling thin, front wall section 33 to door edge 17. With corner member 20, retainer 25 and door rest 30 so affixed to door 12, door 12 is closed within frame 11 and staple guide 21 allows frame plate 22 to be conveniently stapled to door frame 11. Next, flange 29 of retainer 25 is likewise stapled to door frame 11 and preferred door support system 14 is then in place to protect and secure door 12 during shipping and handling. Once door assembly 10 is installed in a building wall opening (not seen), corner member 20, retainer 25 and door rest 30 are then easily removed and conventional door hardware installed so door 12 is then ready for finishing and use.

The illustrations and examples provided herein are for explanatory purposes and are not intended to limit the scope of the appended claims.

I claim:

1. A door support system for a door pre-hung in a frame comprising:
corner member, a retainer and a door rest, said corner member, said retainer and said door rest all attached to said pre-hung door to support the same during transportation and storage.

2. The door support system of claim 1 wherein said corner member comprises an L-shaped bracket, said L-shaped bracket for positioning over the upper corner of the door, between the door and the frame, and a mounting plate, said mounting plate joined to said L-shaped bracket, said mounting plate for attachment to the front surface of the frame to hold said L-shaped bracket in place therebetween.

3. The door support system of claim 2 wherein said mounting plate further comprises a guide, said guide positioned on said mounting plate for positioning a stapler thereon.

4. The door support system of claim 2 wherein said L-shaped bracket defines depression, said depression for receiving a fastener.

5. The door support system of claim 1 wherein said retainer comprises a door edge plate.

6. The door support system of claim 5 further comprising a door throat extension, said throat extension extending perpendicular to said door edge plate.

7. The door support system of claim 6 further comprising a catch, said catch positioned on said throat extension.

8. The door support system of claim 5 further comprising a flange, said flange attached to said door edge plate.

9. The door support system of claim 5 wherein said door edge plate defines an aperture, said aperture for receiving a fastener.

10. The door support system of claim 1 wherein said door rest comprises a base, a foot, said foot attached to said base.

11. The door support system of claim 10 wherein said foot is cylindrically shaped.

12. The door support system of claim 10 wherein said lower rest is formed from plastic.

13. A method of supporting a door with a latch throat pre-hung in a frame attached to a threshold comprising the steps of:
a) attaching a corner member to the top of the door between the door and the frame;
b) attaching a door retainer with an extension to the edge of the door within the door latch throat; and
c) attaching a door rest to the bottom edge of the door to support the same.

14. The method of claim 13 wherein attaching a corner member comprises the step of fastening the corner member to the frame.

15. The method of claim 13 wherein fastening the corner member to the door comprises the step of stapling the corner member to the frame.

16. The method of claim 13 wherein attaching a door retainer comprises the step of attaching a door retainer to the edge of the door with the extension positioned within the latch throat.

17. The method of claim 13 wherein attaching a door rest comprises the step of fastening the door rest to the edge of the door to space the bottom edge of the door from the threshold.
